(19) United States
(12) Patent Application Publication
(10) Pub. No.: US 2016/0239488 A1
(43) Pub. Date: Aug. 18, 2016

(54) ELECTRONIC DOCUMENT SHARING WITH ASYNCHRONOUS PROCESSING ON INDIRECT CHANGES

(71) Applicant: WORKIVA INC., Ames, IA (US)

(72) Inventors: Jason Aguilon, Windsor (CA); Andrew Allen, Louisville, CO (US); MacLeod Broad, Sault Ste Marie (CA); Josh Hayes-Sheen, Sault Ste Marie (CA); Dustin Hiatt, Ames, IA (US); Robert A. Kluin, Boulder, CO (US); Beau D. Lyddon, Boulder, CO (US); Erik Petersen, Sault Ste Marie (CA); Dustin Lessard, Sault Ste Marie (CA)

(21) Appl. No.: 14/700,904

(22) Filed: Apr. 30, 2015

Related U.S. Application Data
(60) Provisional application No. 62/117,915, filed on Feb. 18, 2015.

(51) Int. Cl. G06F 17/30

(52) U.S. Cl. CPC G06F 17/30011; G06F 17/30581; G06F 17/30578

(57) ABSTRACT

A method for sharing changes to an electronic document is described. A share request is received, at a first computing device, that indicates a change to a shared element of the electronic document that is directly changed by a user. A first update set of elements that should be updated based on the change is determined by the first computing device, the first update set including the shared element and one or more elements not directly changed by the user. For each element of the first update set, the first computing device selects between a second update set and a third update set based on a respective dependency relationship with the shared element. Elements of the first update set are associated with the corresponding selected update set. A synchronous update for the second update set and an asynchronous update for the third update set are performed.

### CROSS-REFERENCE TO RELATED PATENT APPLICATION

This application claims the benefit of U.S. Provisional Patent Application No. 62/117,915, entitled “Electronic Document Sharing with Asynchronous Processing on Indirect Changes” and filed on Feb. 18, 2015, the disclosure of which is incorporated herein by reference in its entirety.

### TECHNICAL FIELD

The present disclosure is related generally to electronic document sharing systems and, more particularly, to methods and a computing device for sharing changes to an electronic document.

### BACKGROUND

Document sharing is a mechanism that permits more than one user to edit an electronic document without collision or interfering with the work of other users on the same or related electronic document. An electronic document may be broken down into smaller parts such as elements or sections, and each of these smaller parts may have one distinct user editing it at any one time; a single user may edit multiple parts. A first user who selects a shared electronic document from a display list or icon representing the document may be presented with hierarchically organized outline of the document in a window on the display. The first user can then select a particular document section of the document in order to attempt to edit it. After editing a document section, the first user may attempt to save and share changes they have made to the document section.

If a second user is already in the process of actively editing the section, the outline can indicate that the section is being edited by someone else, for example, by displaying a lock icon next to the section being edited, restricting access by other users. If the first user selects such a section, they can be warned that the document section is being edited, and possibly provided with some information about the edit (such as the editor's name, date/time of the edits, etc.). The first user can also be provided with a mechanism, such as a dialog box, for requesting that the other editor either share or discard their edits so that the section is available to edit.

If no other user is actively editing the section, then that section of the document is opened for editing, and the first user becomes an active editor (“editor”) of that section. In one embodiment, the document section being edited is copied from a server on which the document is stored to the editor's own local device, or displayed at the editor's local device. As the document section is being edited, it may be saved on the server periodically (e.g., every sixty seconds), or based on an express command issued by the editor, so that changes are not lost in the event of problems on the user or a client device. An icon, such as a pencil, can be presented to the editor so the editor knows that they are in the process of editing that particular section.

### SUMMARY

In an embodiment, a method for sharing changes to an electronic document in a distributed networked environment includes receiving, at a first computing device, a share request that indicates a change to a shared element of the electronic document that is directly changed by a user of the electronic document. The method also includes determining, by the first computing device, a first update set of elements that should be updated based on the change to the shared element, the first update set including at least the shared element and one or more elements not directly changed by the user. The method includes selecting, by the first computing device for each element of the first update set, between a second update set and a third update set based on a respective dependency relationship with the shared element for the corresponding element of the first update set. The method also includes associating, by the first computing device, each element of the first update set with the corresponding selected update set. The method also includes performing, by the first computing device, a synchronous update for the second update set. The method also includes performing, by the first computing device, an asynchronous update for the third update set.

In another embodiment, a first computing device of a distributed networked environment for sharing changes to an electronic document includes a non-transitory computer-readable memory and a hardware processor. The hardware processor receives a share request that indicates a change to a shared element of the electronic document that is directly changed by a user of the electronic document. The hardware processor determines a first update set of elements that should be updated based on the change to the shared element, the first update set including at least the shared element and one or more elements not directly changed by the user. The hardware processor selects, for each element of the first update set, between a second update set and a third update set based on a respective dependency relationship with the shared element for the corresponding element of the first update set. The hardware processor associates each element of the first update set with the corresponding selected update set. The hardware processor initiates a synchronous update for the second update set. The hardware processor initiates an asynchronous update for the third update set.

### DESCRIPTION OF THE DRAWINGS

Various embodiments of the invention are illustrated in the following drawings:

FIG. 1 is an example of a networking environment, including a data server and client, in which various embodiments may be used;

FIG. 2 shows a possible implementation of the data server of FIG. 1, according to an embodiment;

FIG. 3 shows a possible implementation of the client of FIG. 1, according to an embodiment;

FIG. 4 is a diagram showing dependency relationships between source elements and target elements, according to an embodiment;

FIG. 5 is a flowchart of an example method for sharing a document section, according to an embodiment;

FIG. 6 is a flowchart of an example method for providing a user interface while sharing a document section, according to an embodiment; and

FIG. 7 is a flowchart of an example method for sharing changes to an electronic document in a distributed networked environment, according to an embodiment.

### DETAILED DESCRIPTION

Disclosed herein is a system and method for document and/or data sharing that utilizes synchronous processing for direct changes and asynchronous processing for indirect changes, in at least some embodiments. Generally, a changed or edited element within an electronic document, even elements that have been saved, are not visible to other users until a “share” is performed (although other users can view the element in its pre-edited form, i.e., the last shared version of the element). In some scenarios, the electronic document includes smaller parts or discrete data elements (e.g., a numeric value representing revenue, the date of an event, the name of a person) shared with other users and/or across other electronic documents. In various embodiments, shared data provides for consistency because there is only one source (i.e., a source element); all other usages of the shared data are references to an original source element such that changes to the source element also propagate to corresponding “target elements” (i.e., elements that reference the source element by formula, function, or some other objectively-detectable mechanism that establishes a directional or bi-directional link between at least two elements). In some embodiments and/or scenarios, a source element is a field, cell, or other suitable element that is linked to a target element (or to multiple target elements). For example, the target element is a field, cell, table, equation, formula, calculation, or other suitable element that utilizes values or numbers stored in or associated with the source element. The target elements and their values are thus dependent on, or have a dependency relationship with, the corresponding source elements. In an embodiment, an electronic document is controlled to permit or deny the use of references to shared data, as well as permit or deny the provision of source elements for shared data. Various mechanisms for saving data elements to a persistent storage, sharing, and thus updating the value of references promotes data integrity as well as a user's perceptions of system responsiveness.

Elements can be constants or variables of various data types, but each element is uniquely addressable so that its parameters and values can be reachable in a networked environment. In some scenarios, an element is a uniquely addressable container that includes or is associated with other elements, for example, a table element that includes cell elements, a document element that includes document section elements (which may further include paragraph elements, etc.). A container element can contain other container elements, a single type of element, multiple types of elements, or various combinations thereof. Accordingly, elements can have nested relationships or dependencies.

Constants may be entered by a user in a form, table, or fielded document, e.g., displayed on a computer screen, or originate from some other data source. Variables are the result of an equation or calculation designed to take other inputs that are either constants or the results of other equations or calculations. In various embodiments, an element is a target element if it refers to one or more other elements and is a source element if it is referred to by other elements. In some scenarios, an element is both a target element and a source element. If an element represents an equation, the equation is stored in or associated with the element as well. Accordingly, in at least some embodiments, dependency relationships or interconnections between elements are fully defined using only the elements themselves.

Once an editor has completed editing an element or a plurality of elements, for example within a document section, and wishes to commit their changes, the editor shares her changes to the elements, thereby making them visible to other users and unlocking the section as well as the contained elements so that others can edit them. Note that an element, document section, or an entire electronic document can automatically be shared when it is initially created. Continuing with the example, above, and alternately, the editor can choose to discard the changes, in which case the changes to elements will be discarded, and the edited section will become unlocked without updating that document section so that other users can edit it.

When sharing a specific element, the system may determine whether any dependencies (i.e., relationships or interconnections) exist between that element and other elements. If dependencies are detected, the editor will be required to share any changes in those elements as well, in an embodiment.

In addition to sharing a single changed element, other elements related to the changed element can also be shared. For example, sharing of a document section can cause an entire document containing that document section to be shared as well. This may be useful if multiple sections have been edited and it is desirable to share them all at once. When an element is shared, including an entire document or other container element, a dependency check is performed to determine whether there are changes in other elements that are linked to the shared element (i.e., target elements where the shared element is a source element), thus requiring indirect changes to be propagated to those target elements as well.

In some embodiments, an icon or button is provided in a user interface for a user to click on when the share is desired. Alternately, the option to share a document section could be presented as some form of menu choice, e.g., a right-click pop-up menu on the outline section, that presents the share option to the editor. At the time of a share, the editor may be presented with a mechanism, e.g., a dialog box, for providing additional information about the shared version, such as notes, or marking it as a milestone (a noteworthy revision level that can be named), that is associated with the document section version revision level. Setting a milestone can add a visual cue to the corresponding revision listed in a document history display area which shows all of the shared versions of a document or document section. This mechanism may also indicate whether the user's changes affect other elements, such as target elements in other documents, and lists those target elements. When changes to the current element are shared, any target elements are also shared. In the alternative to sharing, if the changes are no longer needed, they can be discarded by using similar mechanisms to the share.

Once the sharing is initiated, the system completes the sharing process, described in more detail below, and informs the editor when the share is complete. The editor can be reminded to share the changes if she attempts to log out without sharing the document. In some embodiments, when the editor indicates to the system to share the document, the system: 1) merges all of the editor's changes into the main document; 2) saves that version of the document with a revision number (e.g., for subsequent revisions or reversions to a prior state of the document); 3) clears the pencil icons from the outline sections edited by the editor (or the individual section shared), indicating that they are available to other document editors for editing; and 4) makes all changes visible to all other document users.

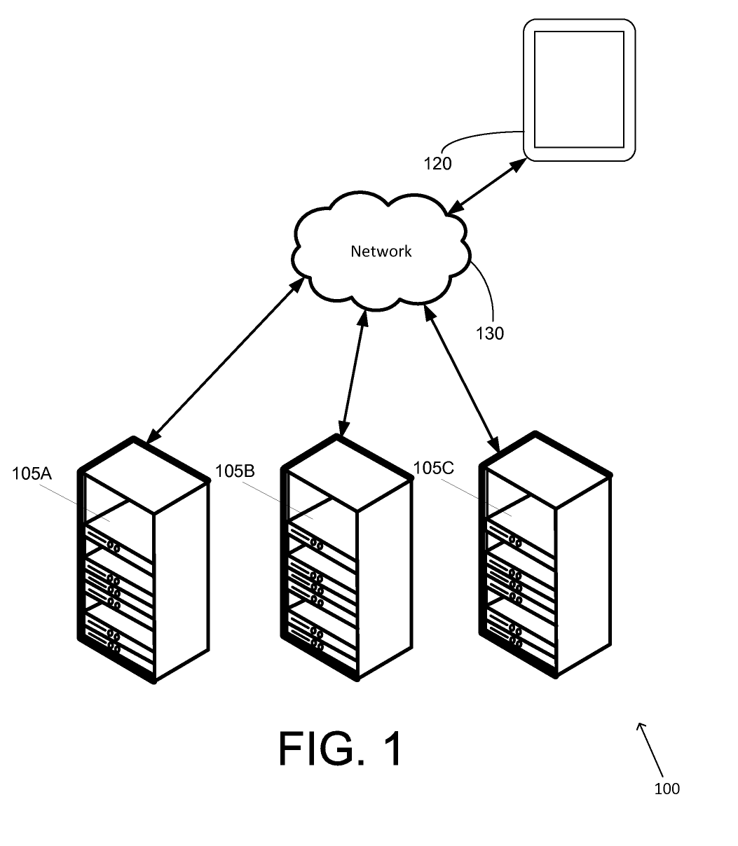

Turning to FIG. 1, in an embodiment, the various methods described herein are carried out by an electronic document sharing system 100. In the embodiment illustrated in FIG. 1, the electronic document sharing system 100 includes first computing devices 105A, 105B, and 105C that are in communication with a second computing device 120 via one or more networks 130 (e.g., a local area network, a wide area network, a wired network, a wireless network, or the Internet). The first computing devices 105A, 105B, and 105C cooperate with each other to act as a cloud-based data server or distributed networked environment, in an embodiment. In other embodiments, the electronic document sharing system 100 includes a single first computing device or a suitable number of computing devices.

For ease of reference, the first computing device is referred to hereinafter as the “data server 105” and the second computing device is referred to as the “client 120.” The first and second computing devices need not be in a server-client relationship, however. Although the data server 105 is depicted in FIG. 1 as rack-mounted server and the client 120 is depicted as a tablet computer, the data server 105 and client 120 may each be implemented as any type of computing device, including a desktop computer, notebook computer, or smartphone. Furthermore, there may be many other computing devices in communication with the data server 105. Although only a single data server is shown in FIG. 1 for clarity, elements within the electronic document sharing system 100 are stored on one or more data servers or computers which are interconnected via the network 130, in various embodiments.

The data server 105 in some embodiments stores, processes, and/or shares elements such as electronic documents, spreadsheets, tables, images, text, databases, or files and provides one or more user interfaces for the client 120. In various embodiments, a user (not shown) may use a user interface, provided by the data server 105, on the client 120, such as a local computer or a remote computer over a network. Likewise, in various embodiments, the electronic document system may operate on a computer local to the user, local to the electronic document sharing system 100, or remote from both over a network. In various embodiments, the electronic document sharing system 100 may be implemented using client-server architectures or as Software as a Service (SaaS) products. The electronic document sharing system 100 may be controlled by and communicate via a user terminal or keyboard/mouse/monitor (not shown).

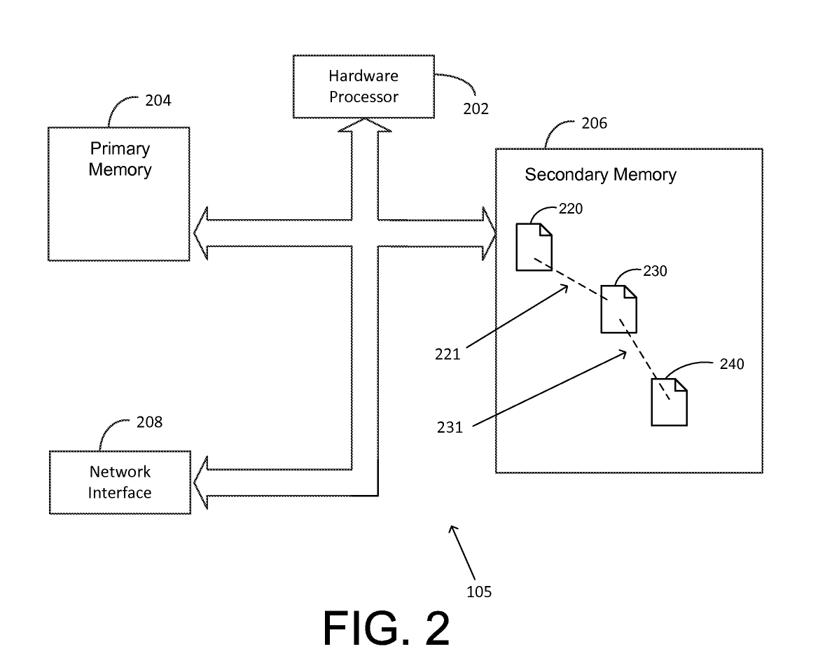

Turning to FIG. 2, a possible implementation of the data server 105 includes a hardware processor 202, a primary memory 204 (e.g., volatile memory, random-access memory), a secondary memory 206 (e.g., non-volatile memory, hard disk memory), and a network interface 208. In various embodiments, the secondary memory 206 (or another suitable memory) stores one or more electronic documents, document sections, or other suitable elements (e.g., spreadsheets, tables, images, or other data), such as document sections 220, 230, and 240. In some embodiments, an element represents a portion of an electronic document that can be independently stored, locked, shared, etc. with other users. The data server 105 in general and the hardware processor 202 in particular are able to communicate with the client 120 of FIG. 1 via the network interface 208 over the network 130. The primary memory 204 stores instructions and data. The hardware processor 202 executes the instructions and uses the data to carry out various procedures including, in some embodiments, the methods described herein. In some embodiments, the data server 105 has one or more distributed components, such as a processor cluster for the hardware processor 202 or a distributed data store for the secondary memory 206, which can be communicated with via the network interface 208, a data bus architecture, or other suitable communication channel.

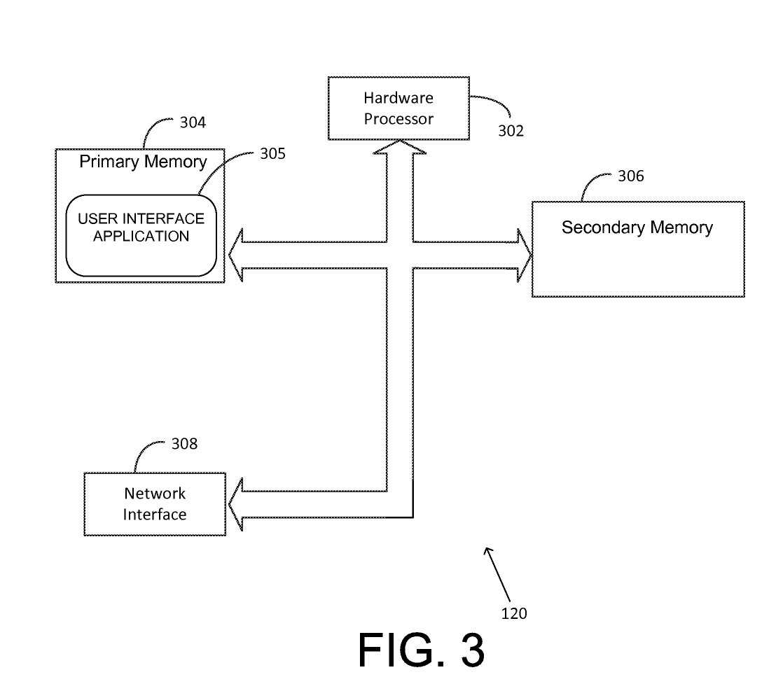

Turning to FIG. 3, a possible implementation of the client 120 includes a hardware processor 302, a primary memory 304 (e.g., volatile memory, random-access memory), a secondary memory 306 (e.g., non-volatile memory, hard disk memory), and a network interface 308. The client 120 in general and the hardware processor 302 in particular are able to communicate with the data server 105 of FIG. 1 via the network interface 308 over the network 130. The memories 304 and 306 store instructions and data. The hardware processor 302 executes the instructions and uses the data to carry out various procedures including, in some embodiments, the methods described herein. In various embodiments, the instructions stored in the memories 304 or 306 include a user interface application 305. The client 120 executes the user interface application 305 and cooperates with the data servers 105 to carry out one or more portions or steps of the methods described herein.

Users may update many different types of documents, including those involving calculations (e.g., spreadsheet documents or other types of documents that allow fields and formulas). When a user makes a change to an element that impacts calculated fields or values in other elements, documents, or document sections, it is desirable to have updates of those changes propagated to the other elements affected by the change. In an embodiment, a user of the client 120 makes a change to a document section of an electronic document in a “draft mode” or when the document is put “in draft.” The client 120 provides a user interface that allows the user to “share” the change (or the document section containing the change), which initiates one or more procedures for propagating the change to the other affected elements, document sections, and/or documents. In an embodiment, when users share changes, the changes (or suitable information corresponding to the changes) are analyzed with a calculation process before the changes are made available to other users of the electronic document sharing system 100. The calculation process ensures that when the changes are shared and ultimately made available to other users, they are in a wholly correct state.

The changes to elements resulting from users' edits can be classified as being either direct changes or indirect changes. As described above, target elements and their values are dependent on, or have a dependency relationship with their corresponding source elements. Such dependencies are not only limited to a first level, but can extend many levels deep, i.e., a change in a first element can cause a change in a second element, which can cause a change in a third element, etc. In the example shown in FIG. 2, a first document section 220 includes a source element corresponding to a target element of a second document section 230, illustrated as a dependency or usage link 221, while the second document section 230 includes a source element corresponding to a target element of a third document section 240, illustrated as a usage link 231.

In various embodiments, the direct changes are those changes to source elements that the editor directly makes herself, and the indirect changes are those changes to target elements that result from the direct changes or other indirect changes. In an embodiment, the electronic document sharing system 100 is configured to separate the changes into two stages for sharing: a direct element share, which is a propagation or sharing out of changes to elements by the editor, and an indirect element share, which is a propagation of changes to elements which depend on the elements directly changed by the editor. In some embodiments, the indirect element share includes updating links, formulas, and calculations for target elements. While only two stages (i.e., direct and indirect) are described for clarity, the changes are separated into additional stages or sub-stages within a stage in other embodiments.

In more detail, an example of a direct element share is when a document is put into draft, for example, by editing a value in a cell (i.e., a source element). The value associated with the source element has been directly modified and therefore, when a share occurs, its value will be propagated to any target elements (e.g., based on dependency relationships). When an editor performs a task across two or more documents that directly modifies elements in each of the two or more documents and thus puts these documents in draft, this is also considered a direct element share case.

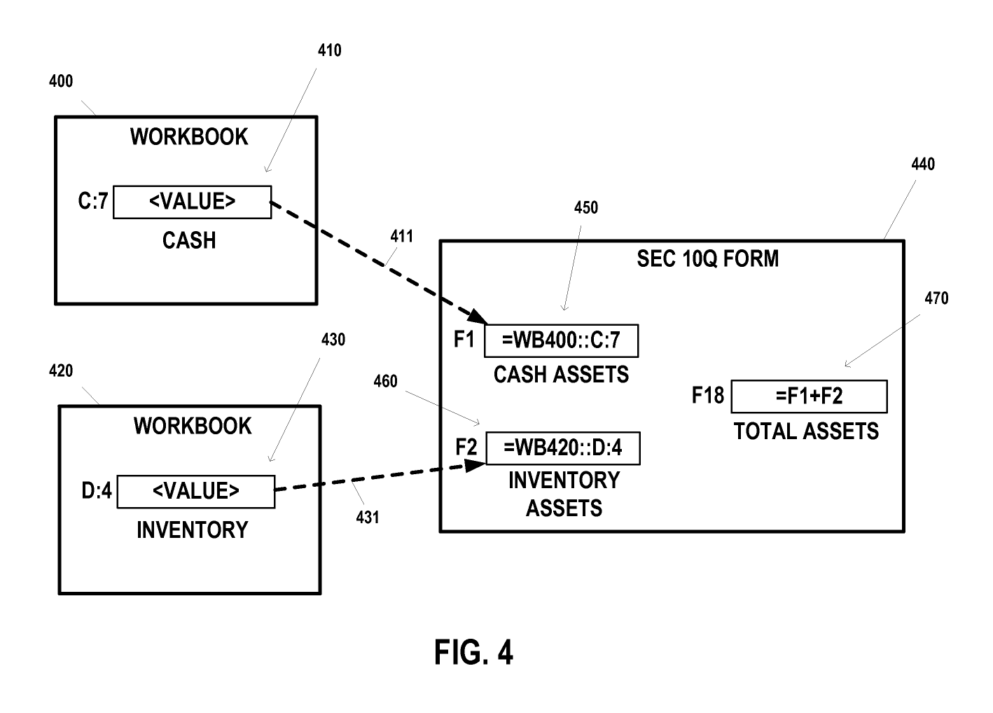

By way of example, FIG. 4 is used to illustrate both direct element shares and indirect element shares. In the example of FIG. 4, a first workbook 400, a second workbook 420, and a form 440 are electronic documents stored by the electronic document sharing system 100. The first workbook 400 is an element that includes one or more cells, such as a cell 410 (illustrated as column C, row 7 of the workbook 400 indicating a cash value). The second workbook 420 is another element that includes one or more cells, such as a cell 430 (illustrated as column D, row 4 of the workbook 420 indicating an inventory value). The form 440 is an element that includes one or more fields, such as a field 450 (illustrated as a field F1 indicating a “Cash Assets” value), a field 460 (illustrated as a field F2 indicating an “Inventory Assets” value), and a field 470 (illustrated as a field F18 indicating a “Total Assets” formula). As an example, the form 440 is an SEC 10Q-compliant form that includes or references values from the workbooks 400 and 420. In various embodiments and/or scenarios, a user (not shown) creates dependencies or usage links between elements by inserting a value or formula (e.g., setting a value of the field F1 to “=WB400::C:7”), copying a link, or performing another suitable command via a user interface.

As an example, the user creates a first usage link 411 between the field 450 (F1) and the cell 410 (C:7) of the first workbook 400, a second usage link 431 between the field 460 (F2) and the cell 430 (D:4) of the second workbook 420, and a formula in field 470 (F18) as the sum of the fields 450 (F1) and 460 (F2). In this example, the cell 410 is a source element for usage link 411, the cell 430 is a source element for usage link 431, and the field 470 is a calculated element.

In some embodiments, the usage links 411 and 431 are stored and/or maintained as “used input lists” and/or “using output lists,” as described in U.S. patent application Ser. No. 13/780,725, filed on Feb. 28, 2013, the contents of which are hereby incorporated by reference. For example, each element corresponds to i) a used input list that indicates source elements which should be obtained during a direct element share and ii) a using output list that indicates target elements which should be updated during an indirect element share.

An example of an indirect element share occurs where one or more recalculating processes that are performed and configured to update document sections that are i) affected by changes corresponding to a direct element share, but ii) not put “in draft” as a result of the changes. In the example described above with respect to FIG. 4, the workbook 400 has source element (cell 410) while the form 440 has a corresponding target element (field 450). The form 440 also has the field 470 with a formula, the calculation of which requires the target element.

The user modifies the value of the source element (cell 410) and thus only the workbook 400 is put into draft. Upon initiation of a share by the user, the electronic document sharing system 100 performs the direct element share which updates the source element and then, as part of the indirect element share, the target element (field 450) in form 440 is updated, as well as the formula of field 470 (which includes the value of the target element). Accordingly, the electronic document sharing system 100 updates the cell 410 during the direct element share and updates the fields 450 and 470 during the indirect element share.

In various embodiments and/or scenarios, separation of the direct element share and the indirect element share allows for the editor's changes to be fully incorporated so that all related documents are in a wholly correct state. A significant amount of time may be needed when a large number of dependency relationships exist, such that it affects the responsiveness of the share operation. In some embodiments and/or scenarios, the electronic document sharing system 100 provides reduced user interface functionality while at least some updates to the elements are performed. In an embodiment, the electronic document sharing system 100 locks the user interface for the document section while processing the direct element share. In other embodiments and/or scenarios, the electronic document sharing system 100 locks only a portion of the user interface or reduces functionality provided by the user interface, for example, by restricting further changes to elements within a corresponding container element (e.g., a document section) while still allowing view-based changes to the user interface (i.e., zoom and scroll functionality), or other suitable user interface changes. Thus, according to an embodiment, when an editor shares the changes to various elements, the direct element share is completed by the electronic document sharing system 100 synchronously with respect to the user interface, meaning that the directly changed elements are shared before control (or restored user interface functionality) is returned to the user. In at least some embodiments, some elements corresponding to the direct element share are shared asynchronously with respect to each other. For example, a plurality of elements within the direct element share which are not dependent on each other can be shared asynchronously with respect to each other, while control is not returned until each element within the direct element share has been updated and thus the direct element share is synchronous with respect to the user interface. In other embodiments, some elements within a direct element share are shared synchronously with respect to each other.

However, the indirect element share may continue to be processed in the background by the electronic document sharing system 100, and at least some features which may depend on a full completion of the share operation can be disabled or provided with reduced functionality until the indirect share is complete, for example to avoid capturing an “in progress” or incomplete state of the elements. Examples of features which may depend on full completion of the share operation include rendering an element or group of elements for: display, storage, archiving, submission or filing with an external system (not shown), generation of a version, revision, exported file having a predetermined file format (e.g., PDF, HTML, Microsoft Word, Microsoft Excel), black line generation or element comparisons (e.g., generating a comparison between versions of a document to indicate changes that have been made), reviews, or other types of revision rendering. Thus, the electronic document sharing system 100 can improve speed, performance, or responsiveness, improve the reliability and handling of failures of shares (particularly shares of a large number of elements), and improve the user experience over a system in which all shares are done synchronously. Advantageously, a user's perceived passage of time needed to share changes is reduced because control is returned to the user, at least partially, after a portion of a total number of those changes has been performed (i.e., the direct element share), instead of waiting for completion of a synchronous share that includes every direct change and indirect change. In some scenarios, complexity and geographic discontinuities of an electronic document sharing system, when changes propagate through millions of target elements, can take hours to perform, thus preventing users from returning to their work for a substantial period of time until a synchronous share is completed.

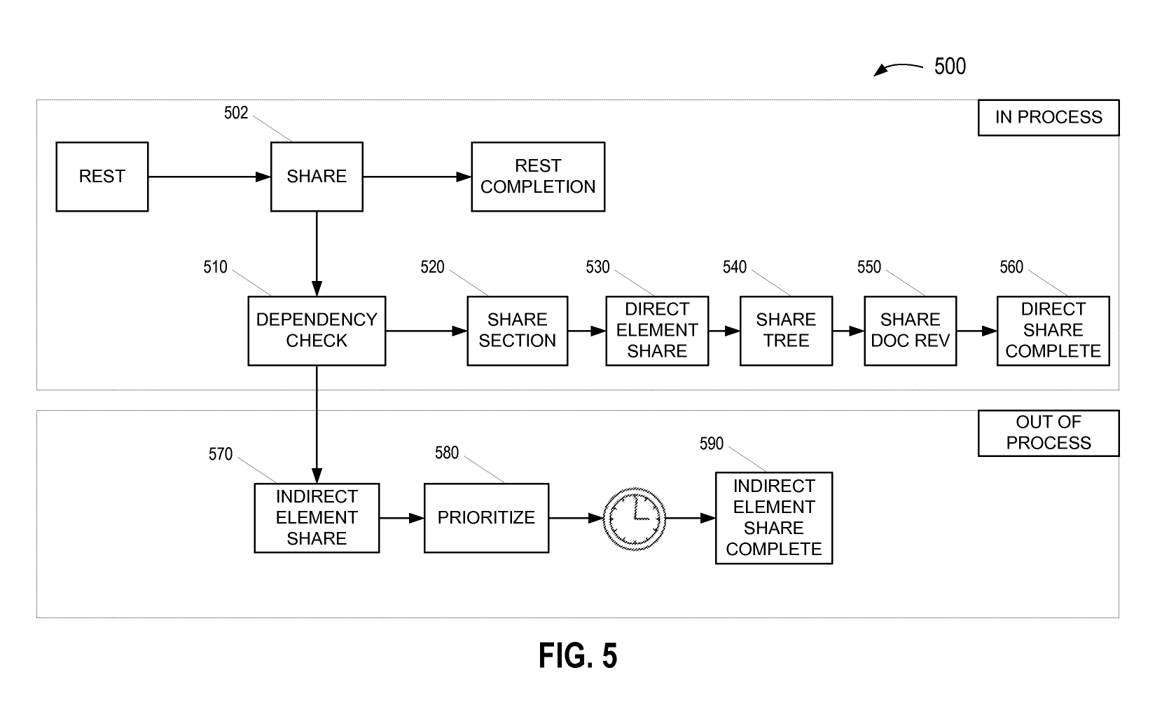

FIG. 5 illustrates an overview of flowchart illustrating a process 500 for performing a share of one or more changed elements, in an embodiment. In the example described, the changed elements include a document section (e.g., a shared document section). The process 500 is performed by the electronic document sharing system 100, for example, by the data server 105, according to an embodiment. In some embodiments, processes and steps that are performed while the user interface appears “locked” to the user are “in process,” while other processes and steps that are performed with reduced user interface functionality are performed “out of process.”

After a user or editor (“sharing user”) has made changes to a document section and the document section has been saved, the sharing user initiates the share 502 via a user interface (e.g., a “share” button) associated with the document section to share or propagate changes made to elements in the document section. In the illustrated embodiment, the share 502 is initiated with a representational state transfer (REST) interface with a callback (REST completion) when the share 502 has completed. In some embodiments, the user interface provides a “share all” command, which attempts to share each element, document section, and/or document that has been changed by the sharing user. In some embodiments, the electronic document sharing system 100 provides the reduced user interface functionality upon initiation of the share 502, as described above.

The electronic document sharing system 100 performs a dependency check 510 on each shared element to determine a first set of elements, document sections, documents, or groups thereof that should be shared. During the dependency check 510, the electronic document sharing system 100 selects between a second update set, for a synchronous update with respect to the user interface via the direct element share, or a third update set, for an asynchronous update with respect to the user interface via the indirect element share. Example criteria for selecting between the direct element share and the indirect element share are described above in the example illustrated by FIG. 4. In an embodiment, shared elements which are directly modified by the sharing user are selected for the direct element share. In another embodiment, if the sharing user performs a task across two or more elements that puts both elements “in draft,” then the two or more elements are handled via the direct element share. For example, reversing a dependency link between elements (making a target element a source element and making its previous source element the target element) results in changes to other target elements which relied upon the previous source element (to refer to the new source element); this editing of element references results in both elements being handled via the direct element share.

In various embodiments and/or scenarios, the electronic document sharing system 100 prioritizes at least some elements to be updated during the share process. In some embodiments, the electronic document sharing system 100 maintains one or more queues of elements to be updated, linked lists, or other suitable data structures, for performing the share according to a determined priority. In one such embodiment, the electronic document sharing system 100 adds shared elements to a first queue for the direct element share or to a second queue for the indirect element share. In some embodiments, elements to be changed are associated with a suitable priority value, for example, to provide higher priority and thus faster updating for at least some elements affected by the share 502. In one example, an element within the second queue for the indirect element share is associated with a high priority value when that element has a relatively high number of target elements as compared to other elements within the second queue. In another example, an element is associated with a high priority value when that element is contained within a same container element as an element of the direct share (i.e., an indirectly changed element in a same document section as a directly changed element). In this example, a document (or other suitable container element, such as a table) in which the sharing user is actively working is more likely to be finished updating (i.e., both direct and indirect elements have been updated) at an earlier time. In yet another example, an element is associated with a high priority value when the element is associated with a high priority user, such as an executive officer or financial auditor. In some examples, a hierarchy of users having different priority levels are provided. In another example, each element associated with an element group (i.e., a project, folder, or other suitable grouping) is associated with a suitable priority value such that the corresponding element group is given a priority adjustment in the queue. In a further embodiment, a combination of these factors are taken into account for establishing a priority for an element. In some embodiments, the electronic document sharing system 100 uses multiple queues to enable share operations to be executed concurrently as part of the overall share process. In one such embodiment, the share operations or queues are handled by different data servers of the electronic document sharing system 100.

Once an element has been determined by the dependency check 510 as requiring a direct element share, the document section (or other element container) comprising the changed element (or elements) is processed 520 for sharing so that the contained elements are up to date and accurate when shared 530. For example, the electronic document sharing system 100 updates values, fields, calculations, formulas, or other suitable elements of the shared element, or moves and/or updates links between elements.

The electronic document sharing system 100 then shares (SHARE TREE 540) related documents and/or document sections based on information from a document outline tree. In an embodiment, for example, a set of document sections are related to each other by a document outline tree (not shown) that indicates an element container or set of elements (e.g., an electronic document) that should be shared together. In one such example, when an electronic document includes a shared document section, the remaining document sections of the electronic document are shared along with the shared document section. Upon completion of the sharing of documents according to the document tree, the electronic document sharing system 100 makes the shared document section available (e.g., publishes the shared document section). In some embodiments, the electronic document sharing system 100 publishes the shared document section as a document revision 550 where a revision level is assigned, any user-entered or predetermined information associated with the assigned revision level is associated with the document revision, and the document revision is made available to other users of the electronic document sharing system 100. In some embodiments, the electronic document sharing system 100 provides restored user interface functionality upon publication of the document revision 550. As an example, the restored user interface functionality is indicated by some form of indication, such as a share button of the user interface changing from a grayed out representation (e.g., inactive) to an active representation. At this point, the direct share portion is complete 560. In an embodiment, when the direct element share is completed, changes that have been shared out are synchronized with the sharing user and other users that happen to have the same elements or sections open, sections are unlocked, and updated document revisions are loaded along with the updated content.

If an element has been determined by the dependency check 510 as requiring an indirect element share 570, the electronic document sharing system 100 performs one or more processes which can be executed asynchronously. Examples of asynchronous processes include performing calculations for fields utilizing changed values, creation of portable document format (PDF) documents, creation of blacklines or revision tracking information, exporting information, performing financial filings, synchronization of the user interfaces, and other suitable activities. In some embodiments, the asynchronous processes are implemented using callback routines in which a callback method is passed as an argument. In some embodiments, notifications are triggered upon update of an element which allows for a determination of whether the indirect updates have completed. Completion may be inferred by the existence of a lock on elements used by the direct share process. Upon completion of the callback routines, the indirect element sharing is complete 580. In some embodiments, loading of an element for viewing or editing by a user requires waiting for indirect element shares associated with the element to complete. For example, the data server 105 provides a lock indication on an element that has pending indirect element shares. As an example using the embodiment illustrated in FIG. 4, a share of the workbook 400 includes a direct element share of the cell 410 and an indirect element share of the field 450, followed by an indirect element share of the field 470. In some embodiments, direct element shares may be performed at least partially concurrently with indirect element shares. In other embodiments, direct element shares may be performed and completed prior to initiation of indirect element shares.

Although editing control is returned to the sharing user (e.g., restored user interface functionality) once the direct share processing is complete 560, thereby permitting the sharing user to more quickly and efficiently begin or continue editing, other elements remaining to be updated by the indirect element share processing are still locked to prevent the current sharing user or other users from accessing them until they are updated. As described above, in some embodiments, elements of the indirect element share in a same document are prioritized (580) to allow the sharing user to continue editing more quickly. In an embodiment, the indirect element share corresponds to elements of a specific revision of a document, thus the subsequent revision of the document is released when the indirect element share is complete (590).

In some embodiments, the user interface includes a progress indicator that indicates intermediate progress during the share of a document section, for example, a progress bar that indicates completed and/or remaining tasks or other suitable indicators. In an embodiment, the progress indicator provides intermediate progress of the direct element share (e.g., the shared document section and documents from which it depends). In another embodiment, the progress indicator provides intermediate progress for the indirect element share, such as calculating formulas, updating fields, or other suitable tasks. In some embodiments, an error status is displayed as well. The user interface includes a share button or other suitable interface element used to initiate a share by the user, according to an embodiment. In some embodiments, the share button is disabled while the direct share is performed (e.g., prior to completion at 560) so that the synchronous operations associated with the direct element share may be completed. Upon completion of the direct element share, the share button is re-enabled and the user interface returns back to an edit mode to allow the editor to make further changes, while the indirect element share appears to the user to take place “in the background.” In some embodiments, the progress indicator is removed or hidden from the user interface upon completion of the corresponding task (e.g., direct element share, indirect element share).

In various embodiments and/or scenarios, the electronic document sharing system 100 provides reduced user interface functionality at suitable times based on a share status or update status of elements displayed within the user interface. In some embodiments, the electronic document sharing system 100 includes a set of user interfaces having different levels or tiers of functionality which are selectively provided based on a share status of elements displayed within the user interface. In an embodiment, the electronic document sharing system 100 provides a first user interface that provides full functionality (e.g., editing and advanced features), a second user interface that provides intermediate functionality (e.g., editing only without advanced features), and a third user interface that provides reduced functionality (e.g., viewing only, no editing or advanced features). In this embodiment, for example, the electronic document sharing system 100 provides to a sharing user: the first user interface when no pending changes are present and/or during editing (i.e., prior to the share process being initiated); the third user interface while a direct element share is performed; and the second user interface while an indirect element share is performed upon elements in the corresponding document or documents. In an embodiment, for example, the electronic document sharing system 100 provides to another user viewing or editing an element that is indirectly affected by the share 502: the second user interface while an indirect element share is performed; and the first user interface upon completion of the indirect element share.

If an element has been accessed by multiple users, the electronic document sharing system 100 provides a separate user interface that is specific to each user, in various embodiments and/or scenarios. The electronic document sharing system 100 provides a user interface to each user that includes a content portion, for the display of a document section requested by that user, and also a menu portion that provides commands for interacting with the document sections and the electronic document sharing system 100. In some scenarios, the electronic document sharing system 100 selects the menu portion based on the share status of one or more corresponding document sections, such as the document sections displayed in the content portion.

In some embodiments, the electronic document sharing system 100 updates the user interface for a specific user when that user initiates a share, as described above, and also updates the user interface for other users. For example, when a first user makes a change to and shares a document section, the electronic document sharing system 100 provides the third user interface with reduced functionality to the first user and also provides the second user interface with intermediate functionality to a second user, such that the second user cannot initiate an advanced function that would interfere with the pending share for the first user. In some embodiments, the user interface provided to a user is based on that user's access level, security privileges, role, or other suitable identifier. For example, a senior editor could be provided any of the first, second, or third user interfaces based on the share status while an assistant editor could be provided only the first or third user interfaces.

While the user interface of the described embodiment includes a content portion, a menu portion, and three levels of functionality, the user interface includes additional or fewer portions and/or additional or fewer levels of functionality in other embodiments. In some embodiments, a single element of a document section is represented by a portion of a user interface which can be controlled or adjusted to have varying levels of functionality.

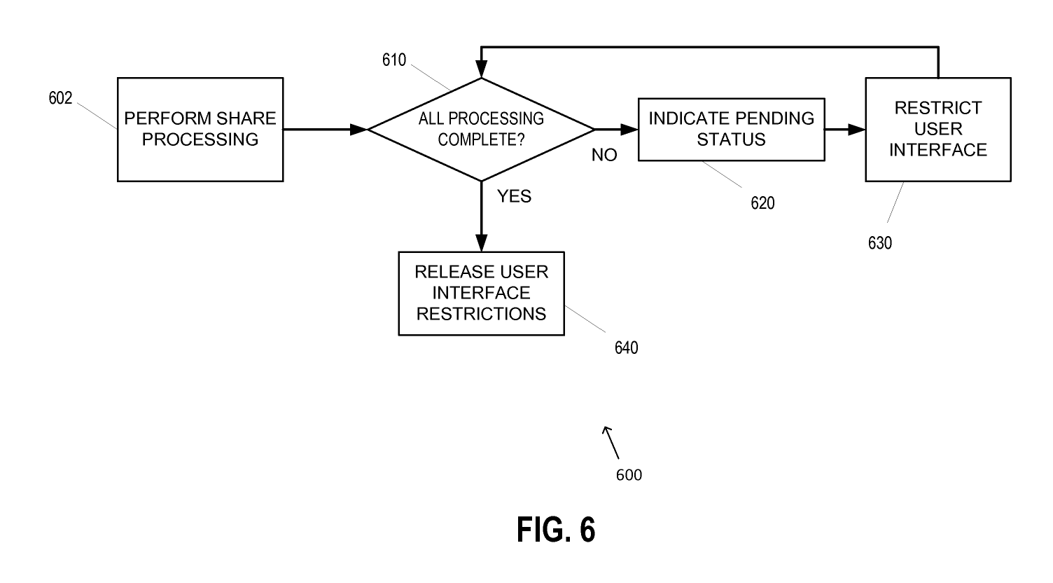

Turning to FIG. 6, a flowchart of an example method 600 for providing a user interface to a user while sharing a document section is shown, according to an embodiment. The method 600 is implemented at least in part by the data server 105, in an embodiment. In other embodiments, another suitable computing device implements the method 600.

At block 602, the data server 105 performs one or more share processes for sharing an element, document section, or electronic document. For example, the data server 105 initiates share processing according to the share 502 described above with respect to FIG. 5. Accordingly, the share processes include the dependency check 510, direct element share 520, and optionally, the indirect element share 570. In some embodiments, the data server 105 is a distributed and/or multi-threaded system, thus multiple instances of the share processes run concurrently.

At block 610, the data server 105 determines whether the share processes initiated at block 602 has completed. For example, the data server 105 determines whether the dependency check 510, the direct element share 520, and the indirect element share 570 have completed. If the share processes have not yet completed, the method proceeds to block 620. At block 620, the data server 105 provides an indication of a pending status for the share processes. For example, the data server 105 provides a user interface that includes a progress indicator that indicates intermediate progress for the share processes, as described above.

At block 630, the data server 105 restricts the user interface to provide reduced user interface functionality, as described above. In an embodiment, the data server 105 selects a user interface from a set of user interfaces based on a completion status of the share processes. As an example, the data server 105 selects i) the third user interface that provides reduced functionality if the direct element share 520 has not yet completed, or ii) the second user interface that provides the intermediate functionality if the direct element share 520 has completed but the indirect element share 570 has not completed. In another embodiment, the data server 105 provides a first user interface to the client 120 through which a share request is received and a shared element is displayed. The data server 105 reduces user interface functionality available via the first user interface in response to the share request and until completion of the synchronous update (e.g., the direct element share). The data server 105 restores at least a portion of the reduced user interface functionality available via the first user interface in response to completion of the synchronous update prior to completion of the asynchronous update, thus allowing a user to return to work in a shared electronic document quickly. The data server 105 restores a remainder of the user interface functionality in response to completion of both the synchronous update and the asynchronous update.

In some embodiments and/or scenarios where multiple users are accessing a same or dependency related element, the data server 105 provides a second user interface to a second user at another client (not shown) through which the same or dependency related element is displayed. The data server 105 reduces user interface functionality available via the second user interface in response to the share request from the first user and until completion of the asynchronous update. The data server 105 restores the user interface functionality available via the second user interface in response to completion of the asynchronous update.

At block 640, upon completion of the share processes as determined at block 610, the data server 105 releases the user interface restrictions. For example, the data server 105 selects the first user interface that provides full functionality when the dependency check 510, the direct element share 520, and the indirect element share 570 have completed.

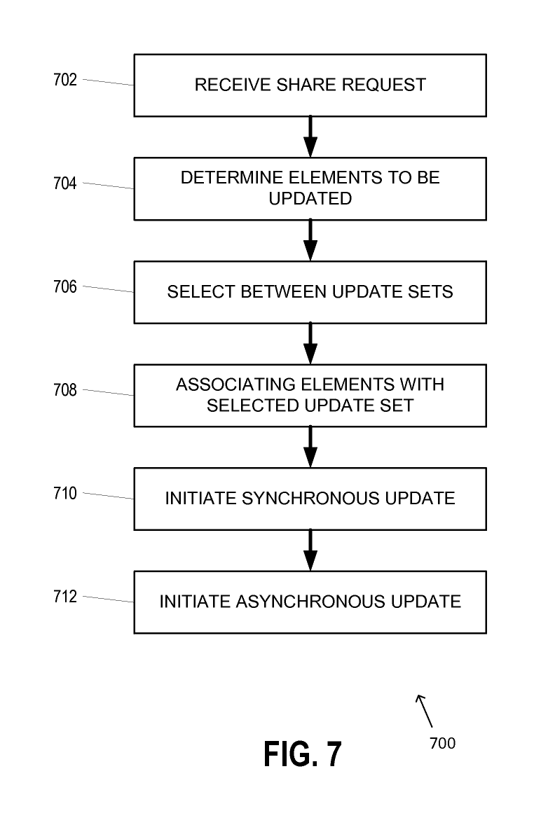

Turning to FIG. 7, a flowchart of an example method 700 for sharing changes to an electronic document in a distributed networked environment is shown, according to an embodiment. The method 700 is implemented at least in part by the data server 105, in an embodiment. In some embodiments, the client 120 implements at least a portion of the method 700. In other embodiments, another suitable computing device implements the method 700.

At block 702, the data server 105 receives a share request from the client 120 (e.g., from a sharing user). The share request indicates a change to a shared element that is directly changed by a user. While the present description describes only one shared element for clarity of explanation, the share request can indicate a plurality of shared elements, document sections, or documents corresponding to direct changes from the user. In some embodiments, each element which has been changed by the sharing user is processed according to the share request.

At block 704, the data server 105 determines a first update set of elements that should be updated based on the change to the shared element. The first update set of elements includes the shared element and also elements not directly changed by the user (e.g., those requiring indirect changes). For example, the data server 105 performs the dependency check 510 on the shared element, as described above with respect to FIG. 5 to determine the first update set. In some embodiments, the data server 105 determines another update set of elements that should be updated based on indirect changes and adds the other set of elements to the first set of elements for processing by block 706, as described below. The data server 105 locks the element(s) (or an electronic document that contains the element(s)) of the first update set, or provides reduced user interface functionality, until the corresponding updates have been performed, in an embodiment.

At block 706, the data server 105 selects, for each element of the first update set, between a second update set and a third update set based on a respective dependency relationship with the shared element for the corresponding element of the first update set. In an embodiment, the second update set corresponds to the direct element share and the third update set corresponds to the indirect element share, as described above with respect to FIG. 5.

At block 708, the data server 105 associates each element of the first update set to the selected update set (i.e., the second update or the third update set), in an embodiment.

At block 710, the data server 105 initiates a synchronous update, with respect to the user interface, for the elements corresponding to the second update set. For example, the data server 105 initiates a direct element share for elements corresponding to the second update set and causes the third user interface, having reduced functionality, to be provided to the sharing user, as described above with respect to FIG. 6. In an embodiment, the data server 105 distributes one or more update tasks for performing the synchronous update to additional network devices, for example, additional instances of the data server 105 within a distributed networked environment or cloud-based system.

At block 712, the data server 105 initiates an asynchronous update, with respect to the user interface, for the elements corresponding to the third update set. For example, the data server 105 initiates an indirect element share for elements corresponding to the third update set. In an embodiment, the data server 105 causes the second user interface, having intermediate functionality, to be provided to the sharing user as well as other users of documents impacted by the indirect element share, as described above with respect to FIG. 6. In an embodiment, the data server 105 distributes one or more update tasks for performing the asynchronous update to additional network devices, for example, additional instances of the data server 105 within a distributed networked environment or cloud-based system. In an embodiment, the data server 105 initiates the synchronous update (at block 710) and the asynchronous update (at block 712) to be performed at least partially concurrently. For example, the data server 105 initiates the asynchronous update before completion of the synchronous update. In another embodiment, the data server 105 initiates the asynchronous update (at block 712) in response to completion of the synchronous update (at block 710).

In some embodiments, the data server 105 adds elements included in an adjacency list for the shared element to the first update set of elements. For example, the data server 105 adds the used input list and the using output list to the first update set of elements and selects i) the second update set for the used input list, and ii) the third update set for the using output list.

The data server 105 implements the second update set and/or third update set as a queue, in at least some embodiments. For example, when selecting (706) between the second update set and a third update queue, the data server 105 adds an element to the third update queue in order based on a priority value corresponding to the element. The data server 105 then performs the asynchronous update for the third update queue in the order based on the priority values. Examples of priority values are described above, with respect to FIG. 5. In some embodiments and/or scenarios, the data server 105 updates the priority value for an element (or elements) or promotes an element within a list of elements to be updated if the element is requested by another user (e.g., the element is contained in a document that a user has attempted to open).

In an embodiment, the data server 105 performs the synchronous update synchronously with respect to a user interface and also prevents further changes to the second update set and the third update set via the user interface while the synchronous update is performed. In this embodiment, the data server 105 performs the asynchronous update asynchronously with respect to the user interface, allows further changes to the second update set via the user interface upon completion of the synchronous update and while the asynchronous update is performed, and prevents further changes to the third update set via the user interface upon completion of the synchronous update and while the asynchronous update is performed. The data server 105 then allows further changes to the third update set upon completion of the asynchronous update.

The data server 105 performs the synchronous update (i.e., for the second update set) synchronously with respect to the user interface and the asynchronous update (i.e., for the third update set) asynchronously with respect to the user interface; however, updates to individual elements within the respective update set can be performed synchronously or asynchronously with respect to each other, in at least some embodiments. For example, the data server 105 performs updates to individual elements, or sets of elements, within the second update set synchronously and/or asynchronously with respect to each other and synchronously with respect to the user interface based on the dependency relationships. In an embodiment, the data server 105 determines whether a first element of the second update set (i.e., direct element share) has a dependency relationship with a second element of the second update set. The data server 105 performs a first update of the first element and a second update of the second element. The first update and the second update are performed by the data server 105 i) asynchronously with respect to each other and ii) synchronously with respect to the user interface, in response to a determination that the first element and the second element do not have a dependency relationship with each other (e.g., neither element is dependent on the other). The first update and the second update are performed by the data server 105 synchronously with respect to each other and synchronously with respect to the user interface in response to a determination that the first element and the second element have a dependency relationship with each other. In some embodiments, the data server 105 creates a plurality of update sets in a hierarchy such that updates are performed asynchronously for elements (or update sets) if the elements are not dependent on each other.

In some embodiments, the data server 105 determines whether a first element of the third update set (i.e., indirect element share) has a dependency relationship with a second element of the third update set. The data server 105 performs a first update of the first element and a second update of the second element. The first update and the second update are performed by the data server 105 asynchronously with respect to each other and asynchronously with respect to the user interface in response to a determination that the first element and the second element do not have a dependency relationship with each other. The first update and the second update are performed by the data server 105 synchronously with respect to each other and asynchronously with respect to the user interface in response to a determination that the first element and the second element have a dependency relationship with each other. In some embodiments, the third update set is separated into a fourth update set that excludes terminating leaf nodes (i.e., elements that represent an end point of a dependency relationship or dependency relationship chain) and a fifth update set that includes only the terminating leaf nodes. In one such embodiment, the second update set is updated synchronously with respect to the user interface, after which control is returned to the user as described above. Upon completion of the synchronous update to the second update set, the data server 105 performs an update to the elements of the fourth update set, asynchronously with respect to the user interface, but synchronously with respect to each other where applicable (e.g., elements having a dependency relationship are updated in order). Upon completion of the update to the fourth update set, the data server 105 performs an update of the fifth update set, asynchronously with respect to the user interface and asynchronously with respect to each other because, as terminating leaf nodes, their changes need not be propagated further and do not affect other elements.

It can be seen from the foregoing that methods and systems for sharing changes to an electronic document in a distributed networked environment have been provided. In view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

The apparatus described herein may include a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

The disclosed embodiments may be described in terms of functional block components and various processing steps. Such functional blocks may be realized by any number of hardware and/or software components configured to perform the specified functions. For example, the disclosed embodiments may employ various integrated circuit components, e.g., memory elements, processing elements, logic elements, look-up tables, and the like, which may carry out a variety of functions under the control of one or more microprocessors or other control devices. Similarly, where the elements of the disclosed embodiments are implemented using software programming or software elements, the disclosed embodiments may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the disclosed embodiments may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, “device”, “controller”, and “construction” are used broadly and are not limited to mechanical or physical embodiments, but may include software routines in conjunction with processors, etc.

No item or component is essential to the practice of the disclosed embodiments unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the disclosed embodiments (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

The use of any and all examples, or exemplary language (e.g., “such as”) provided herein, is intended merely to better illuminate the disclosed embodiments and does not pose a limitation on the scope of the disclosed embodiments unless otherwise claimed. Numerous modifications and adaptations will be readily apparent to those of ordinary skill in this art.

1. A method for sharing changes to an electronic document in a distributed networked environment, the method comprising:
receiving, at a first computing device of the distributed networked environment, a share request that indicates a change to a shared element of a section of the electronic document that is directly changed by a user of the electronic document;
determining, by the first computing device, a first update set of elements to be updated based on the change to the shared element, the first update set including at least the shared element and one or more elements not directly changed by the user;
dividing, by the first computing device, elements of the first update set into a second update set and a third update set, wherein the second update set comprises at least the shared element, and the third update set comprises one or more elements of the first update set that are not directly changed by the user and not in the section of the electronic document;
providing, by the first computing device to a second computing device, a first user interface through which the share request is received and the section of the electronic document is displayed;
disabling one or more user interface functionality features of the first user interface in response to the share request;
updating, by a first set of computing devices, elements of the second update set based on the change to the shared element while the one or more user interface functionality features of the first user interface are disabled;
enabling at least a portion of the one or more user interface functionality features of the first user interface in response to completion of the update of the elements of the second update set; and
updating, by a second set of computing devices, elements of the third update set based on the change to the shared element after enabling at least the portion of the one or more user interface functionality features of the first user interface.

2. The method of claim 1, wherein the second update set further comprises one or more elements of the first update set that are in the section of the electronic document displayed through the first user interface but are not directly changed by the user.

3. The method of claim 2, wherein performing the update for the second update set comprises updating the shared element prior to updating the one or more elements that are in the section of the electronic document but are not directly changed by the user.

4. (canceled)

5. The method of claim 1, wherein:
the third update set is a third update queue;
dividing the first update set comprises adding an element of the first update set into the third update queue in order based on a priority value corresponding to the element of the first update set; and
updating the elements of the third update set comprises updating the elements of the third update queue in the order based on the priority values.

6. (canceled)

7. The method of claim 1, further comprising:
enabling a remainder of the one or more user interface functionality features of the first user interface in response to completion of both the update of the second update set and the update of the third update set.

8. The method of claim 1, further comprising:
providing, by the first computing device to a third computing device, a second user interface that is distinct from the first user interface and through which at least one element of the first update set is displayed;
wherein providing the second user interface comprises:
disabling one or more user interface functionality features of the second user interface in response to the updating of the elements of the second update set; and
enabling the one or more user interface functionality features of the second user interface in response to completion of an update of at least one element of the third update set.

9. The method of claim 1, further comprising:
determining, by the first computing device, a fourth update set of elements to be updated based on updates to the one or more elements not directly changed by the user;
dividing, by the first computing device, an element of the fourth update set into the second update set if the element of the fourth update set is in the section of the electronic document; and
dividing, by the first computing device, the element of the fourth update set into the third update set if the element of the fourth update set is not in the section of the electronic document.

10. The method of claim 1, wherein updating the elements of the second update set comprises:
preventing further changes, via the first user interface, to the elements of the second update set and the elements of the third update set while the update of the second update set is performed;
wherein updating the elements of the third update set comprises:
preventing further changes to the elements of the third update set while the update of the elements of the third update set is performed.

11. (canceled)

12. The method of claim 1, wherein updating the elements of the second update set comprises:
determining whether a first element of the second update set has a dependency relationship with a second element of the second update set;
performing a first update of the first element and a second update of the second element;
wherein the first update and the second update are performed asynchronously with respect to each other and synchronously with respect to the first user interface in response to a determination that the first element and the second element do not have a dependency relationship with each other;
wherein the first update and the second update are performed synchronously with respect to each other and synchronously with respect to the first user interface in response to a determination that the first element and the second element have a dependency relationship with each other.

13. The method of claim 1, wherein updating the third update set comprises:
determining whether a first element of the third update set has a dependency relationship with a second element of the third update set;
performing a first update of the first element and a second update of the second element;
wherein the first update and the second update are performed asynchronously with respect to each other and asynchronously with respect to the first user interface in response to a determination that the first element and the second element do not have a dependency relationship with each other;
wherein the first update and the second update are performed synchronously with respect to each other and asynchronously with respect to the first user interface in response to a determination that the first element and the second element have a dependency relationship with each other.

14. A first computing device of a distributed networked environment for sharing changes to an electronic document, the first computing device comprising:
a non-transitory computer-readable memory;
a hardware processor that:
receives a share request that indicates a change to a shared element of a section of the electronic document that is directly changed by a user of the electronic document;
determines a first update set of elements to be updated based on the change to the shared element, the first update set including at least the shared element and one or more elements not directly changed by the user;
divides elements of the first update set into a second update set and a third update set, wherein the second update set comprises at least the shared element, and the third update set comprises one or more elements of the first update set that are not directly changed by the user and not in the section of the electronic document;
provides, to a second computing device, a first user interface through which the share request is received and the section of the electronic document is displayed;
disables one or more user interface functionality features of the first user interface in response to the share request;
initiates an update of elements of the second update set based on the change to the shared element while the one or more user interface functionality features of the first user interface are disabled;
enables at least a portion of the one or more user interface functionality features of the first user interface in response to completion of the update of the elements of the second update set; and
initiates an update of elements of the third update set based on the change to the shard element after enabling at least the portion of the one or more user interface functionality features of the first user interface.

15. The first computing device of claim 14, wherein the second update set further comprises one or more elements of the first update set that are in the section of the electronic document displayed through the first user interface but are not directly changed by the user.

16. The first computing device of claim 14, wherein the hardware processor adds elements included in an adjacency list for the shared element to the first update set, the adjacency list comprising:
a used input list of source elements, the source elements being separate from the shared element, the list of source elements defining each source element that is used by the shared element in its calculation, and
a using output list of target elements that use the shared element in a calculation, the target elements being separate from the shared element;
wherein the hardware processor divides the elements of the first update set into i) the second update set for the used input list of source elements, and ii) the third update set for the using output list of target elements.

17. The first computing device of claim 14, wherein the third update set is a third update queue and the hardware processor adds an element of the first update set into the third update queue in order based on a priority value corresponding to the element of the first update set;
wherein the hardware processor updates the elements of the third update queue in the order based on the priority values.

18. The first computing device of claim 14, wherein the hardware processor:
prevents further changes, via the first user interface, to the elements of the second update set and the elements of the third update set while the update of the second update set is performed; and
prevents further changes to the elements of the third update set while the update of the elements of the third update set is performed.

19. The first computing device of claim 18, wherein the hardware processor:
determines whether a first element of the second update set has a dependency relationship with a second element of the second update set;
performs a first update of the first element and a second update of the second element i) asynchronously with respect to each other and synchronously with respect to the first user interface in response to a determination that the first element and the second element do not have a dependency relationship with each other, or ii) synchronously with respect to each other and synchronously with respect to the first user interface in response to a determination that the first element and the second element have a dependency relationship with each other.

20. The first computing device of claim 14, wherein the hardware processor distributes one or more first update tasks for the update of the elements of the second update set and one or more second update tasks for the update of the elements of the third update set to third computing devices of the distributed networked environment.

21. The method of claim 1, further comprising:
providing, by the first computing device to a third computing device, a second user interface through which at least one element of the first update set is displayed;
wherein providing the second user interface comprises:
disabling one or more user interface functionality features of the second user interface in response to the performing of the update for the third update set; and
enabling the one or more user interface functionality features of the second user interface in response to completion of an update of at least one element of the third update set.

22. The method of claim 1, wherein the update for the second update set is performed simultaneously as the update for the third update set.

23. The method of claim 1, wherein the update for the second update set is performed before the update for the third update set.

24. The method of claim 1, wherein disabling the one or more user interface functionality features of the first user interface comprises disabling further changes to the shared element via the first user interface.
